(19) United States
(12) Patent Application Publication
(10) Pub. No.: US 2005/0205537 A1
(43) Pub. Date: Sep. 22, 2005

(54) Processing device and method of controlling same

(75) Inventors: Andreas Penz, Scharten (AT); Stephan Fazeny, Gmunden (AT)

Correspondence Address: COLLARD & ROE, P.C., 1077 Northern Boulevard, Roslyn, NY, 11576, US

(73) Assignee: TROTEC Produktions u. Vertriebs GmbH

(21) Appl. No.: 11/082,705

(22) Filed: Mar. 17, 2005

(30) Foreign Application Priority Data
Mar. 18, 2004 (AT) A 470/2004

(51) Int. Cl. B23K 26/36

(52) U.S. Cl. 219/121.72; 219/121.73; 219/121.6

(57) ABSTRACT

The invention relates to a processing device (1) and a method of controlling several processing tools (3, 4) of a processing device (1) for processing the material of workpieces (2). The workpiece (2) can be processed by a first processing tool (3), which is generated by a first radiation source (9), in particular a laser source, in the form of a processing beam (8a), and by means of at least one other processing tool (4) of a different nature or different origin, in particular a different radiation source (10), from the first processing tool (3), whereby the different processing tools (3, 4) can be placed in contact with a workpiece (2) in order to process the material, and processing of a workpiece (2) can be performed by only one of the processing tools (3; 4) at any one time.

### CROSS REFERENCE TO RELATED APPLICATIONS

Applicants claim priority under 35 U.S.C. §119 of AUSTRIAN Patent Application No. A 470/2004 filed on 18 Mar. 2004.

### BACKGROUND OF THE INVENTION

1. Field of the Invention

The invention relates to a method of controlling several processing tools of a processing device as well as a processing device, of the type described in the introductory parts of claims 1 and 19.

2. Prior Art

Processing devices are already known from the prior art, which have a radiation source for generating a laser beam in order to process the material of workpieces, for example by cutting or engraving. The portion of the laser beam directed onto the workpiece is freely displaceable in a two-dimensional working plane or an XY-plane and, this being the case, the displacing motion is set by means of a control system, in particular a computer system. Processing devices of this type usually have only one radiation source for generating the laser beam for processing purposes, which can be regulated.

Also known from the prior art are laser processing systems which have several radiation sources for generating laser beams and the individual laser beams are grouped to form a single working beam. A device of this type is known from patent specifications U.S. Pat. No. 6,423,925 B1 and U.S. Pat. No. 6,313,433 B1, for example. In the case of these processing systems, the laser sources are always operated parallel with one another in order to increase the energy in the processing beam directed onto the workpiece due to the combined, co-linear beam pattern or in order to increase the processing speed due to a simultaneous but separate beam pattern from several processing beams of the same type acting simultaneously on a workpiece achieved by scanning the workpiece in a multi-line or raster-type pattern.

Also known from patent specification U.S. Pat. No. 4,877,939 A is a device for processing by means of laser radiation, which has a first radiation source for generating a laser beam with a first wavelength and another radiation source for generating a working beam with a wavelength that is different from that of the first beam. This being the case, the first laser beam is responsible for the main processing of the workpiece, in particular the removal of material, whilst the other laser beam is responsible for pre-processing the surface, in particular for pre-heating the workpiece. Accordingly, the workpiece is processed consecutively by the two beams and along the same processing path so that the proportion of radiation of the processing laser reflected by the workpiece can be reduced. Several processing beams for separately processing different material types or for separately finishing workpieces are not provided.

The disadvantage of the laser processing devices and processing methods known from the prior art is that they have processing tools of only one type in the form of a single working beam, by means of which processing work can be carried out on the workpiece. In the prior art systems, the working beam or processing beam, which may or may not be made up of several individual superposed beams, has a specific wavelength or is limited to a specific spectrum of a wavelength. Consequently, only workpieces of a specific or restricted category of materials can be processed with processing devices of this type and workpieces with totally different material properties or of a non-homogeneous structure have to be processed with the appropriate tools on separate respective processing devices. In the past, it has therefore been necessary to use separate respective processing devices to process workpieces with specific processing properties, incurring high procurement costs, increased operating costs and an increased space requirement.

### SUMMARY OF THE INVENTION

The objective of the present invention is to propose a method of controlling several processing tools of a processing machine, by means of which a more comprehensive and more flexible selection of workpieces with different properties, in particular different materials or structures, can be processed.

The objective of the invention is achieved, independently in each case, on the basis of the characterising features defined in claims 1 and 19. The advantage achieved as a result of these characterising features primarily resides in the fact that a processing device of this type enables a more comprehensive and variable range of options for processing workpieces with different material properties or the processing of workpieces with intrinsically inconsistent structures, for example of a structured design with non-homogeneous materials. Due to the possibility of separately selecting one of the processing tools, the processing tool best suited to the workpiece can be selected depending on the processing properties of a workpiece, i.e. either the processing beam generated by the first radiation source or the other processing tool may be used. This means that it is also possible to process workpieces which can not be processed by the processing beam generated by the first radiation source, for example due to too high or low a power output, because the processing quality would not be satisfactory or the workpiece would be damaged, whereas the workpiece can be processed by the other processing tool, which can be or is adapted to the specific processing properties of a different group of materials.

The advantage of the characterising features defined in at least one of claims 2 or 20 is that the structure of the processing device can be kept simple by jointly using at least part sections of a beam deflection system due to the fact that there are at least two independent radiation sources by means of which the processing beam, in particular the laser beam, can be generated. Furthermore, a specific amount of thermal energy can be applied for each processing beam, making it possible to process workpieces in a very versatile manner. Consequently, the processing device is able to perform a range of processing techniques on materials, such as engraving, cutting, heating and pre-warming or pre-heating, evaporation, foaming, colour changing or bleaching.

The features defined in at least one of claims 3 or 21 are of advantage because certain processing techniques can be effectively carried out on a workpiece with each of the radiation sources, which have different wavelengths, in particular depending on a material, which means that different materials such as plastics or metals can be processed by means of processing beams provided specifically for this purpose. Furthermore, the processing beams have different properties and each can be used to perform specific or a series of specific processing techniques. For example, the first processing beam generated by the first radiation source may be set up to perform a surface treatment on the workpiece, in particular tempering or heating, colouring, etc., and a processing beam generated by the other source may be set up for processing whereby material is removed from the workpiece, in particular a cutting or severing process or engraving, in which case any number of other processing tools may be provided for carrying out special processing techniques.

The features defined in claim 4 or 21 are of advantage because experience has shown that a laser combination of this type is very highly efficient and enables different processing techniques to be performed to a very high degree of efficiency, whilst enabling different types of workpiece to be processed.

As a result of the features specified in at least one of claims 5 to 7 or 22 to 24, a plurality of methods or systems known from the prior art as a means of removing material may be performed or carried out using the processing device proposed by the invention, thereby securing the required high degree of processing flexibility.

The features defined in claim 8 are of advantage because they ensure that only one of the processing tools is in active contact with the workpiece at any one time and the desired processing technique can be carried out whilst the other processing tools remain inactive.

The features pertaining to a controller of the processing beams defined in at least one of claims 9 or 28 expediently ensure that the beam generated by the radiation sources which is not acting on the workpiece at any time is deactivated or not available.

The features defined in at least one of claims 10 or 25 are of advantage because they offer another practical option via the feed or drive system whereby the contact or action of the processing tool on the workpiece can be controlled without having to shut down or disable the operating mode of the processing tools.

Claim 11 defines advantageous features by means of which the pattern of the optical paths or paths of the processing beams can be mutually defined in the beam deflection system, thereby fixing the way in which the processing beams will act on the workpiece.

The features specified in at least one of claims 12 or 26 are of advantage because the operating device can be controlled by means of a control unit, in particular on an automated basis, and the way in which one of the processing tools acts on the workpiece in an alternating manner can be determined beforehand. On the basis of control signals or pre-set switch positions defined at the control unit, it is possible to prevent a situation in which the workpiece is inadvertently processed by two processing tools simultaneously and in parallel.

The features defined in at least one of claims 13 or 27 are of advantage because the specified switch element provides a practical means of controlling the processing tools, in particular activating or deactivating the radiation sources, whereby the action of only one of the processing tools can be clearly set up by means of the change-over switch.

The features defined in at least one of claims 14 or 29 are of advantage because when the different processing beams are set to a co-linear optical path or radiation path, they can be directed by means of the same elements or deflector mirror in the beam deflection system, which makes the structure of the beam deflection system compact. Another advantage may reside in the fact that when a first processing tool is deactivated at a processing point on the workpiece as the other processing tool is activated, the latter acts on the same processing point and processing along the processing path can be continued seamlessly, which is an advantage if workpieces have varying properties, for example due to different materials or differently shaped structures.

The features defined in at least one of claims 15 or 30 are of advantage because the optical paths of the processing beams generated or to be generated by the different radiation sources leave the beam deflection system at different points and hit different processing points on the workpiece at a distance apart from one another or hit different workpieces. For example, this also offers an option whereby processing can be undertaken on a first workpiece by a processing beam of the first radiation source, whilst on another workpiece, a processing beam of the other radiation source can perform a process on the other workpiece at the same time. The optical paths or paths of the different processing beams can therefore be moved and controlled independently of one another, which means that the output of the different processing beams and their independent processing paths can be selectively controlled via the control unit.

The features defined in at least one of claims 14, 15 or 31 are also of advantage because the optical paths or travel of the processing beams are guided by means of the same or separate deflector mirrors, in which case the structure of the processing device will be more compact or more cost-effective or, alternatively, a high degree of operating flexibility can be achieved by using optical paths or travel which can be controlled independently and separately from one another.

The features of at least one of claims 16 or 32 are of advantage because the action of one or more processing tools on the workpiece can be calibrated by means of a calibration tool. Accordingly, embodiments of the type specified in claims 17, 18 or 33, 34 are particularly practical because when using processing beams as processing tools, the path of a calibration beam from another radiation source which does not carry out processing on the workpiece can be set up in the beam deflection system so that the path of the calibration beam is co-linear with the processing beams using very simple means so that the contact of the processing beams on the workpiece can be simulated very exactly. This being the case, the calibration beam preferably has a different output power or wavelength from the processing beams, as a result of which the calibration beam may be selectively operated simultaneously with the processing beam on one and the same workpiece.

### BRIEF DESCRIPTION OF THE DRAWINGS

The invention will be described in more detail below with reference to examples of embodiments illustrated in the appended drawings. Of these:

FIG. 1 illustrates a processing device proposed by the invention in a production plant, viewed from an angle;

FIG. 2 illustrates a perspective view of one possible embodiment of the processing device proposed by the invention, seen from an angle;

FIG. 3 illustrates a perspective view of another embodiment of the processing device, seen from an angle.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

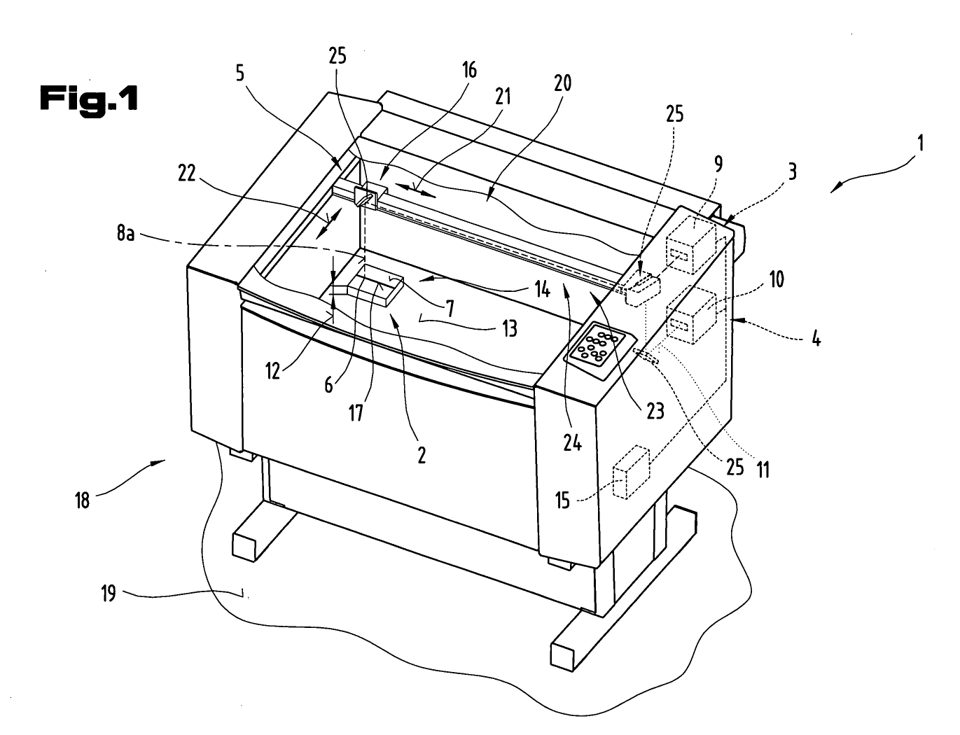

FIG. 1 illustrates a processing device 1 proposed by the invention, designed for processing workpieces 2. The processing device 1 has several processing tools 3, 4, each of which carries out a process on a material, for example removes material or heats the material of a workpiece 2. In principle, the processing device 1 has at least two processing tools 3, 4, although any number of processing tools 3, 4 may be provided.

The processing device 1 also has a displacement system 5, by means of which the processing tools 3, 4 can be manipulated in such a way in terms of their action on the workpiece 2 that a processing point 6 on the workpiece 2, at which a processing tool 3; 4 is in contact with a surface 7 of the workpiece 2 is moved relative to it. To this end, the displacement system 5 for producing a displacement, in particular in an XY-plane, is actively connected to the processing tools 3, 4.

A first processing tool 3 is effectively provided in the form of a processing beam 8a, which is generated or emitted by a first radiation source 9 and which is produced by electromagnetic waves. Accordingly, the radiation source 9 is preferably a laser source, suitable for generating a processing beam 8a in the form of a laser beam with a first wavelength.

The at least one other processing tool 4 is of a different or alternative type or nature or of a different origin from that of the first processing tool 3.

The different processing tools 3, 4 alternately co-operate with the workpiece 2 and only one of the processing tools 3, 4 processes the material of the workpiece 2 at any one time. An operating sequence of this type is of advantage because one of several appropriate processing tools 3; 4 can be selected for different processing situations depending in particular on a structure or material of the workpiece 2, and different processing sequences can therefore be performed on the workpiece 2 with the processing device on the basis of an alternative or alternating selection of one of the processing tools 3; 4. Consequently, there is no need for any parallel operation for simultaneously processing the same workpiece 2 using several processing tools 3, 4, in particular superposition of processing beams 8a, 8b in order to level the energy of the processing beam 3; 4.

Processing tools 3, 4 of different types may therefore be different in nature so that they permit different processing techniques, for example mechanical or cutting, thermal or chemical techniques for removing material. The other processing tool 4 may be provided in the form of a different material-removing means operating in a different way from the first processing beam 8a of the first processing tool 3 in order to perform one of said processing techniques. In the case of removing material from the workpiece 2, the other processing tool 4 might be a mill, drill, chisel or similar, or spark or arc generated by a difference in electric potential, in particular for a spark erosion process, or a pressurised medium with a high speed relative to the workpiece 2, in particular a fluid, such as a water jet or a gas.

The processing tools 3, 4 may also be of the same nature or type but of different origin, in particular from a different source. A preferred embodiment, which will be described in detail below, might be such that the processing tools 3, 4 are each generated and emitted from separate radiation sources 9, 10. In the embodiment illustrated as an example in FIG. 1, the other processing tool 4 is provided in the form of a processing beam 8b generated by the other radiation source 10, in which case the radiation source 10 is preferably also a laser source for generating the processing beam 8b in the form of a laser beam. This being the case, the processing tools 3, 4 are of the same type and are so in the form of processing beams 8a, 8b, but the processing beam 8a, 8b preferably have different properties or characteristics, in particular different wavelengths or output power.

In respect of understanding the diagrams given in FIGS. 1 to 3, it should be pointed out that the active processing beam 8a or the one in contact with the workpiece 2 is indicated by dotted-dashed lines and an imaginary path of the other processing beam 8b, which is inactive or not in contact with the workpiece 2, is shown with dotted lines indicating its optical path 11, with a view to providing a clearer understanding. In principle, at any one time, only one of the two processing beams 8a; 8b is in contact with and processing the material of the same workpiece 2.

The processing device 1 can be used to process the workpiece 2 by removing material, for example, in particular engraving, pinion-cutting, cutting or similar, or may be used for a thermal treatment method such as heating or similar. In order to engrave the workpiece 2, material can be removed from the surface 7 of the workpiece 2 across a depth that is shorter than the thickness 12 of the workpiece 2, or the material can be removed from the workpiece 2 across the entire thickness 12 of the workpiece 2 if using the processing tools 3, 4 in a cutting or severing process. The processing device 1 proposed by the invention is not restricted to a specific type of material to be processed but is characterised by the fact that the plurality of different processing tools 3, 4 which can be used with it make it more flexible in terms of processing different materials, for example metals, plastics, textile materials, natural fibres or similar.

Workpieces 2 disposed on a workpiece holder 13 can therefore be processed by means of the processing tools 3, 4 in processing zones 14 and the processing sequence is preferably controlled and/or regulated via at least one control unit 15 which is connected or can be connected to the processing tools 3, 4 and/or the displacement system 5. Accordingly, the displacement system 5 can be automatically controlled so that a processing head 16, from the output end of which the part of the processing tool 3, 4 directed towards the workpiece 2 for removing material extends, can be displaced or moved along a processing path 17 on the basis of signals pre-set from the control unit 15 in order to control and regulate the displacement system relative to the workpiece holder 13 and the workpiece 2. The control unit 15 is preferably provided in the form of a computerised computer system which generates control signals via a control logic or software stored in a memory element by means of a micro-processor in order to control the processing tools 3, 4.

As illustrated in FIG. 1 by way of example, the processing device 1 is preferably designed for use in a production plant 18, being positioned on a support surface 19, and in the embodiment illustrated as an example here has an interior 20 in which the workpiece holder 13 as well as the processing tools 3, 4 can be displaced by means of the displacement system 5 in the directions indicated by arrows 21, 22. The workpiece holder 13 is provided in the form of a support base and the workpiece holder 13 may naturally be provided with clamping and/or positioning devices in order to hold the workpiece 2 in a fixed position, for example a mechanical clamping mechanisms such as vice jaws or positively fitting positioning frames. Production plants 18 of the type illustrated in FIG. 1 are known from the prior art in terms of their basic structure and a detailed explanation of their design will therefore not be given at this juncture. The production plant 18 illustrated in FIG. 1 is but one example of a potential application of the processing device 1 and the processing device 1 may be designed as a separate unit which operates independently of such a production plant 18.

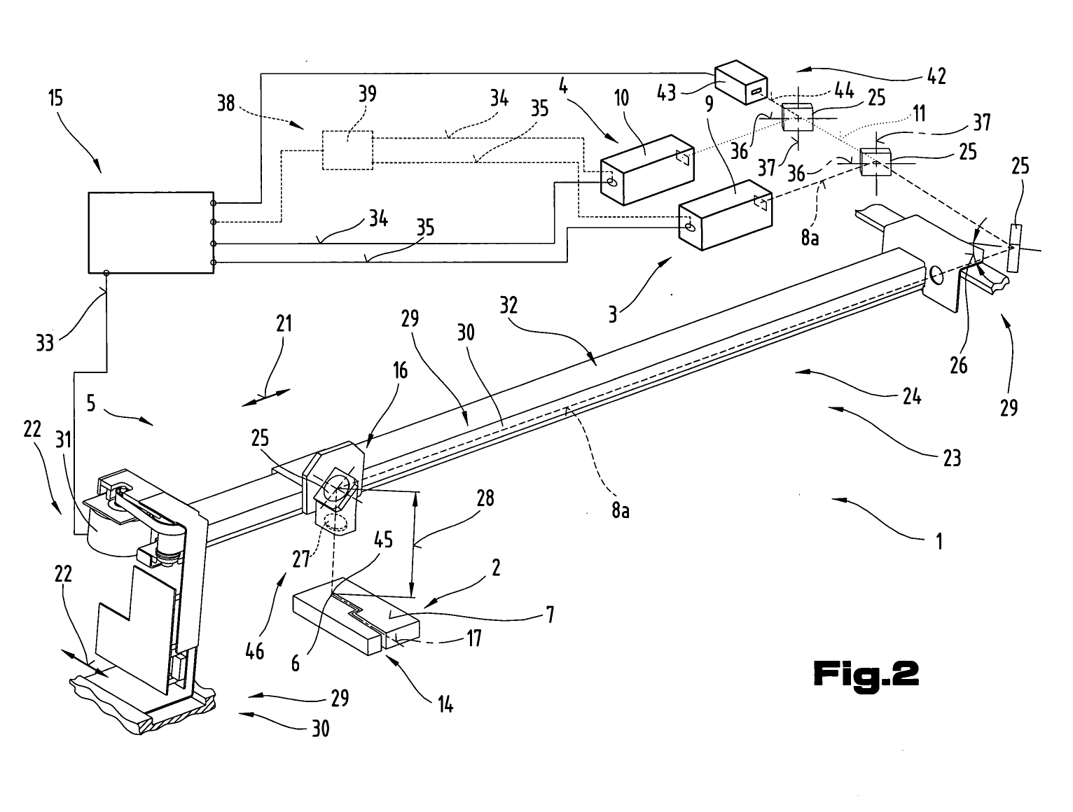

FIG. 2 illustrates the processing device 1 with the displacement system 5 and the tools 3, 4 which can be displaced by it.

The processing device 1 may have a feed or drive system 23, by means of which the processing tools 3, 4 can be placed in contact or co-operation with the workpiece 2 in order to process the material. The feed or drive system 23 is primarily designed to generate energy and/or transmit energy or supply energy in order to operate the processing tools 3; 4 when they are in contact with the workpiece 2. As illustrated in FIG. 2, the feed or drive system 23 incorporates the radiation sources 9, 10 and an optical beam deflection system 24 for transporting the active processing beams 8a; 8b from one of the radiation sources 9; 10 to the processing point 6 on the workpiece 2 in active mode.

In the embodiment illustrated as an example in FIG. 2, the processing tools 3, 4 are respectively generated by means of the radiation sources 9, 10 and the processing beam 8a, 8b generated by them, each along a specific optical path 11 defined by the beam deflection system 24. The processing beams 8a, 8b are fed to the workpiece 2 across the feed or drive system 23 provided by means of the beam deflection system 24. To this end, the beam deflection system 24 has several optical elements for deflecting the beam, in particular deflector mirrors 25, which reflect the processing beam 8a, 8b hitting them at an angle of incidence at a reflection angle 26. In what follows below, the processing head 16 takes the form of the unit comprising a focussing lens 27 and a deflector mirror 25 disposed upstream of it, which emits the processing beam 8a; 8b at the output end of the feed or drive system 23 onto the workpiece 2, i.e. which directs or deflects the processing beam 8a; 8b via a portion 28 directly onto the surface 7 of the workpiece 2. The processing beam 8a; 8b deflected by the deflector mirror 25 of the processing head 16 therefore passes through the focussing lens 27, which bundles the processing beam 8a; 8b on the processing point 6, in particular a burning point. The burn width between the processing point 6 and focussing lens 27 can therefore be adjusted, in a manner known from the prior art.

The displacement system 5 is designed to displace the processing head 16 linearly in two directions, preferably along two axes in a Cartesian system of co-ordinates, so that the processing head 16 is displaceable at least in an X-direction as indicated by arrow 21 and a Y-direction as indicated by arrow 22. Accordingly, the processing head 16 can be displaced in a two-dimensional XY-plane extending parallel with the support base or the workpiece holder 13, for example, and the displacement system 5 is connected to the control unit 15 so that it can be controlled and/or regulated. In order to generate a displacement, the displacement system 5 may have guide systems 29, in particular a linear guide 30, and a motion generator 31, in particular a rotary motor, the motion generator 31 being actively connected by means of transmission elements, such as belts or similar, to the guide systems 29, in particular linear guides 30. Devices for generating motion and for converting rotary motion into linear motion, for example toothed racks or spindle drive systems and such like, are known to the skilled person from the prior art and will not be discussed in detail here. The processing head 16 constitutes the last moving member of the kinematic chain of motion of the displacement system 5 and it can therefore be displaced linearly in the directions indicated by arrows 21 and 22, in which case it has proved to be of practical advantage to dispose the processing head 16 on a beam-type support arm 32, as illustrated, which can be displaced by means of said guide systems 29.

At this stage, it should be pointed out that other systems known from the prior art may be used as a means of positioning objects in conjunction with the processing device 1 proposed by the invention, to which end track or co-ordinates of a point-controlled manipulation and displacement system may be used, in particular manipulators with two degree of freedom for producing a linear displacement in a plane.

The control unit 15 is connected to the motion generator 31 via a control line 33 to enable it to be controlled and regulated and via other control lines 34 and 35 to the radiation sources 9, 10. Consequently, the displacement system 5 can be controlled via the control unit in order to position the processing head 16 at any point within a possible processing range, preferably the XY-plane, along a processing path 17 pre-set or computed by the control unit 15. At this stage, it should also be pointed out that the displacement system 5 may also be designed to effect displacements within a three-co-ordinate system, in which case it would be possible to displace the processing head 16 in three directions.

For the purposes of the invention, the processing tools 3, 4 in the processing device 1 are designed so that only one of the at least two processing tools 3; 4 of a different nature or origin is able to perform a process on a workpiece 2 at any one time. To this end, one out of all the processing tools 3, 4 can be switched into an active mode and the other processing tools 3, 4 are switched into an inactive or passive mode. The active and passive processing tools 3, 4 may be manually fixed, e.g. by user inputs, or may be fixed by an automated control logic or a control programme.

The processing tool 3; 4 which is in active mode is therefore such that it performs processing on the workpiece 2 alone at any one time, in other words is designed for single operation, and the at least one other processing tool 3; 4 is out of action or out of contact with said workpiece 2 at this time. To this end, the processing tools 3, 4 at this time, in particular the radiation sources 9, 10, are controlled in a type of alternative or alternating circuit, so that they can respectively be activated or deactivated separately or by a mutual coupling, and when one of the processing tools 3; 4 is activated, the at least one other processing tool 3; 4 is or remains deactivated in alternation, i.e. is not actively processing the workpiece 2. With the processing device 1 proposed by the invention, the processing tools 3, 4 are and can therefore be controlled in such a way that only one of the processing tools 3; 4 is processing the material of a workpiece 2 at any one time.

One of the processing tools 3; 4 can be deactivated in such a way that the processing beam 8a; 8b in contact with the processing point 6 on the workpiece 2 is placed out of action or out of contact with the workpiece 2. This may be done either by shutting down or reducing the power of the processing beam 8a; 8b to a zero level or by deflecting or turning aside the processing beam 8a; 8b so that it is no longer directed onto the workpiece 2 and is no longer in contact with it. In order to shut down or throttle the output power of the at least one radiation source 9, 10 in the region of a zero value, the control unit 15 connected to the radiation source 9, 10 via the control line 34, 35 may control or regulate the energy output by the radiation sources 9, 10 in the form of the processing beam 8; 8a accordingly.

Furthermore, the processing tools 3, 4 may be deflected and moved out of contact or co-operation with the workpiece 2 by displacing the feed or drive system 23. This is done in particular by means of said deflection of the processing beam 8a; 8b by displacing individual deflector mirrors 25, in particular in the processing head 16, of the beam deflection system 24, so that although the active processing beam 8a; 8b of a radiation source 9, 10 is active within a part section of the beam deflection system 24, the processing beam 8a; 8b is not actually directed onto the surface 7 of the workpiece 2.

A so-called beam switch may be provided as a means of deflecting or moving aside the active processing beam 8a; 8b, which is disposed close to the radiation sources 9, 10 in particular. The beam switch may made up of individual components of the beam deflection system 24, in particular individual deflector mirrors 25, which are actively connected to a drive or displacement system, although this is not illustrated, in which case the deflector mirrors 25 are pivotable about axes 36, 37 and/or in their longitudinal direction and/or transverse direction by means of guide carriages or similar. The active processing beams 8a; 8b may be controlled by moving a deflector mirror 25 into the optical path 11 and positioned in order to steer the desired processing beam 8a; 8b in the requisite direction in the beam deflection system 24 and by deflecting the at least one other processing beam 8a; 8b away from the common optical path 11. Other possible ways of deflecting the beam include the provision of optical lock elements, in particular sliding screens or similar to block off a processing beam 8a; 8b or the provision of a displaceable, for example pivotable, mount for the radiation sources 9, 10 in order to set the emission angle of the processing beam 8a; 8b. Other variants of the beam deflection system 24, in particular as regards the disposition and number of deflector mirrors 25 and their displacement paths with a view to controlling the action of the processing beams 8a, 8b, lie within the capability of the skilled person and for the sake of simplicity will not be discussed further here.

In the embodiment illustrated in FIG. 2, the deflector mirrors are disposed so that they are rigidly positioned in the beam deflection system 24, in which case a common or controlled optical path 11 is achieved by means of deflector mirrors 25 of a semi-transparent design, i.e. deflector mirrors 25 which reflect on one side and allow the radiation to pass through on the other side. In FIG. 2, the deflector mirror 25 disposed down-stream of the laser source 9 is of the semi-transparent type, the design of such deflector mirrors 25 provided with special coatings, for example, being known from the prior art.

The processing work of the processing tools 3, 4 can be activated and deactivated via the control unit 15, which is connected to the processing tool 3, 4 or the feed or drive system 23 for control and regulation purposes. The processing tools 3, 4 or individual components, in particular the deflector mirrors 25, feed or drive system 23, may be activated or deactivated via switch elements 38 of the control unit 15. For example, a switch element is mounted on each of the radiation sources 9, 10 so that the processing beam 8a, 8b is emitted by the radiation source 9, 10 in one switch position and a processing beam 8a, 8b that is being generated is interrupted or no longer generated in a shut-down position.

The broken lines in FIG. 2 indicate another example of a switch element 38, comprising a symbolically indicated change-over switch 39, by means of which an input line connected to it can be switched to several lines. As illustrated, the control output of the control unit 15 connected to the input end of the change-over switch 39 can be switched to one of the control lines 34, 35 connected to the radiation sources 9, 10. Naturally, it would also be possible to provide a switch element 38 in the form of an alternating switch 39 of this type in a power supply line between a power source and the radiation sources 9, 10 and a desired processing tool 3, 4 can be connected to the power source, not illustrated, by determining the switch position of the change-over switch 39, thereby enabling the processing tool 3; 4 to be placed in operation and activated accordingly. Other variants of switch elements 38 and electronic circuits for activating or deactivating the radiation sources 9, 10 are within the capability of the person skilled in the art and therefore constitute designs equivalent to those specifically described in respect of the invention.

The embodiment illustrated in FIG. 2 is one in which the two radiation sources 9, 10 in the beam deflection system 24 are directed onto the workpiece 2 along the same optical path 11—indicated by dotted lines—defined by the deflector mirrors 25, only one of the processing beams 8a; 8b —indicated by broken lines—being active. If the processing tool 3, 4 is changed by deactivating a processing tool 3 that was previously in operation and activating the processing tool 4 that was previously not operating, the processing point 6 on the workpiece 2 remains unchanged and it is then the processing tool 4 that was previously not in operation which is now disposed on the processing point 6. As a result, when the first processing tool 3 is processing the workpiece 2, it can be deactivated, in which case the displacement system 5 remains in a non-operating position from the instant of deactivation, so that when the other processing tool 4 is activated, processing of the workpiece 2 can be continued at the same processing point. Consequently, a workpiece 2 that is non-homogeneous and has alternating material properties or zones with differing processing requirements can be processed with the appropriate processing tools 3, 4.

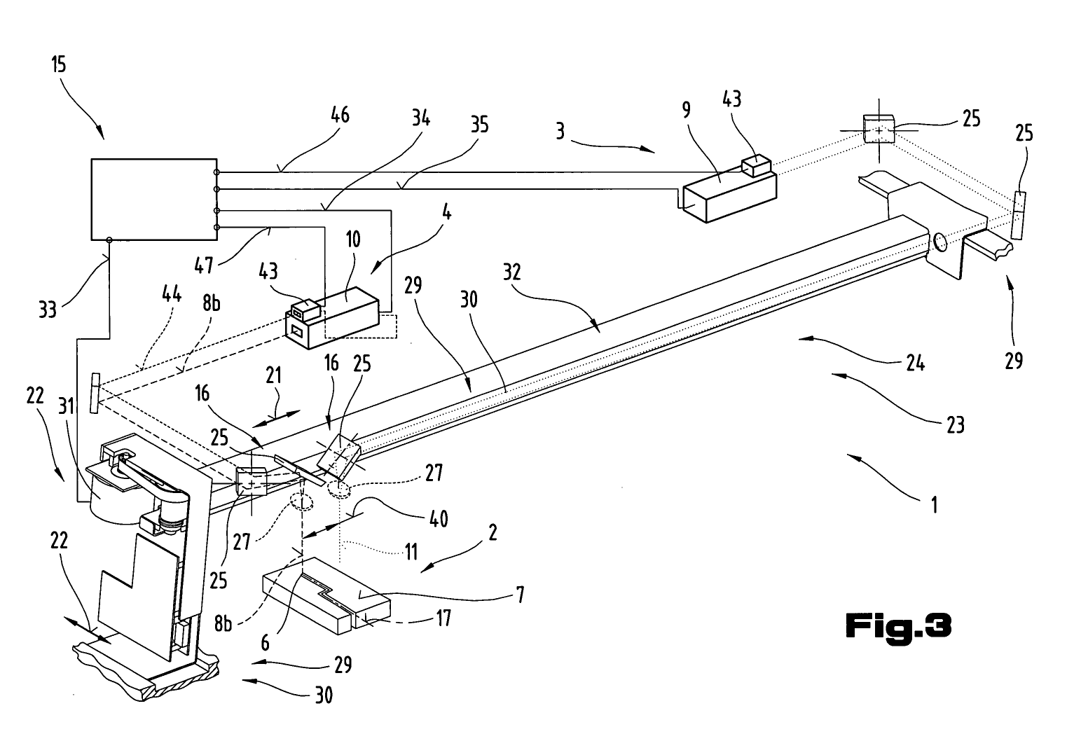

FIG. 3 illustrates an example of another embodiment of the processing device 1 proposed by the invention, in which the processing tools 3, 4 are again provided in the form of radiation sources 9, 10, each of which is designed to emit a processing beam 8a, 8b, in particular a laser beam.

The processing beams 8a, 8b of the different radiation sources 9, 10 in this case are directed onto the workpiece 2 along differently extending, in particular separate, optical paths 11. To this end, a separate deflector mirror 25 is provided for each of the processing beams 8a, 8b.

As illustrated, the two processing beam 8a, 8b do not make contact with the workpiece 2 at the same processing point 6 and instead, the output-side portions 28 of the different processing beams 8a, 8b, which are directed along their optical paths 11 onto the workpiece 2, are respectively emitted from the beam deflection system 24 at a distance 40 apart from one another. The processing beam 8b indicated by a broken line is acting on the workpiece 2 and a dotted line indicates what is only the imaginary optical path 11 of the other processing beam 8a, which is not active. Two processing heads 16, illustrated in a highly simplified format (without housing, etc.) are displacingly coupled with the displacement system 5 and preferably form a jointly displaceable processing unit, as illustrated. Naturally, it would also be possible for the individual processing heads 16 to be displaceable or movable independently of one another via the displacement system 5 and separate processing paths 17 fixed for each processing head 16 via the control unit 15.

Another option is for the optical paths 11 of the different processing beams 8a, 8b to follow the same path in only partial sections of the beam deflection system 24, as is the case illustrated in FIG. 2.

Although not illustrated, attention is drawn to the processing option which can be carried out by the processing device 1 whereby the different processing tools 3, 4 of the processing device 1 are activated simultaneously at one instant but each is used to actively processes different workpieces 2. In particular, the processing beams 8a, 8b may be controlled separately from one another so that each of them is directed by the beam deflection system 24 onto a processing point 6 of different workpieces 2 to permit parallel processing of several workpieces 2.

As regards the radiation sources 9, 10, it should generally be pointed out that a processing beam 8a with a first wavelength or output is generated by the first radiation source 9 and a processing beam 8b with a wavelength or output that is different from that of the first processing beam 8a is generated by the at least one other radiation source 10. To this end, the radiation sources 9, 10 may be provided in the form of different types of laser sources, for example gas lasers, in particular carbon dioxide lasers, fixed body lasers, in particular Nd:YAG lasers, fluid lasers or semiconductor lasers, etc. It has proved to be particularly effective if a CO₂ laser is used for the first processing tool 3, provided in the form of a processing beam 8a. A preferred embodiment can only be one in which, in addition to the first processing beam 8a generated by a CO₂ laser source, another processing beam 8b from a fixed body laser, in particular a Nd:YAG laser source, is used as another processing tool 4, because these two laser types have different processing characteristics, which means that different groups of materials, each with special processing requirements, e.g. metals and plastics, can be processed with the processing device 1.

As illustrated in FIGS. 2 and 3, the processing device 1 may also incorporate a calibration tool 42, by means of which the processing tools 3, 4 can be set up beforehand and calibrated for removing material from the processing point 6 on the workpiece 2. The calibration tool 42 is preferably provided in the form of a calibration beam 44 generated by another radiation source 43, which is directed onto the surface 7 of the workpiece 2 via the beam deflection system 24 in order to form a focussing point 45.

By adjusting the calibration tool 42, calibration or adjustment of the contact of the one or more processing tools 3, 4 on the workpiece 2 can be simulated and the setting of the calibration tool 42 by means of a coupling with the appropriate processing tools 3, 4 enables the action on the workpiece 2 to be set. To this end, the radiation sources 43 used to generate the calibration beams 44 may be connected via control lines 46, 47 to the control unit 15 in order to transmit signals. The calibration beam 44 enables a display of the processing tool 3; 4 acting on the workpiece 2 to be generated on activation, which display renders the contact or action of the processing tool 3; 4 visible, in particular from the appearance of the focussing point 45 projected onto the surface 7 of the workpiece 2. By calibrating the calibration beam 44, the processing beam 8a; 8b can be simultaneously calibrated, preferably via the control unit 15, especially by setting a power of the radiation sources 9, 10 and/or the bum width between the focussing lens 27 and the surface 7 of the workpiece 2.

To this end, the calibration beam 44 is provided in the form of a radiation source 43 designed to generate coloured light, for example red, green or blue light, and the calibration beam 44 in the beam deflection system 24 runs in a co-linear arrangement with the optical path 11 of at least one of the processing beams 8a, 8b.

This being the case, it is possible for each radiation source 9, 10 to be provided with a calibration tool 42 of this type, in particular the radiation source 43 used to generate the calibration beams 44, and each of the radiation sources 9, 10 used to generate the processing beams 8a, 8b is calibrated separately by means of the calibration tool 42 before the system is switched on.

It is also possible for the optical path 11 of the calibration beam 44 generated by the radiation source 43 to be switched between the optical paths of several processing beams 8a, 8b generated by radiation sources 9, 10 so that several processing beams 8a, 8b of the radiation sources 9, 10 can be calibrated with only one calibration beam 44 by changing the optical path 11.

The examples of embodiments illustrate possible embodiments of the processing device 1, although it should be pointed out that the invention is not restricted to the specific embodiments described here and instead, various other combinations of the individual embodiments may be used in conjunction with one another. In view of the teaching regarding the technical aspects of the subject matter proposed by the invention, these various options lie with the ability of the skilled person engaged in this technical field. For example, all embodiments would be conceivable, based on combinations of individual details taken from the described embodiments without departing from the scope of the invention.

For the sake of good order, it should finally be pointed out that, in order to provide a clearer understanding of the structure of the processing device 1, it and its constituent parts are illustrated to a certain extent out of scale and/or on an enlarged scale and/or on a reduced scale.

The independent inventive solutions proposed as a means of achieving the objective may be found in the description. Above all, the individual embodiments of the subject matter illustrated in FIGS. 1; 2; 3 may be construed as independent solutions proposed by the invention in their own right. The objectives and solutions proposed by the invention may be found in the detailed descriptions of these drawings.

List of Reference Numbers

1 Processing device
2 Workpiece
3 Processing tool
4 Processing tool
5 Displacement system
6 Processing point
7 Surface
8a Processing beam
8b Processing beam
9 Radiation source
10 Radiation source
11 Optical path
12 Thickness
13 Workpiece holder
14 Processing zone
15 Control unit
16 Processing head
17 Processing path
18 Production plant
19 Support surface
20 Interior
21 Arrow
22 Arrow
23 Feed and drive system
24 Beam deflection system
25 Deflector mirror
26 Angle of reflection
27 Focussing lens
28 Portion
29 Guide system
30 Linear guide
31 Motion generator
32 Support arm
33 Control line
34 Control line
35 Control line
36 Axis
37 Axis
38 Switch element
39 Change-over switch
40 Distance
41 Processing unit
42 Calibration tool
43 Radiation source
44 Calibration beam
45 Focussing point
46 Control line
47 Control line

1. Method of controlling several processing tools of a processing device in order to process the material of workpieces, wherein the workpiece can be processed by a first processing tool in the form of a processing beam generated by a first radiation source, in particular a laser source, and at least one other processing tool of a different type or different origin, in particular a different radiation source, from the first processing tool, whereby the different processing tools can be applied alternately to a workpiece in order to process the material and only one of the processing tools performs processing on the workpiece at any one time.

2. Method according to claim 1, wherein the at least one other processing tool is a processing beam generated by the other radiation source, in particular another laser source.

3. Method according to claim 1, wherein the first processing beam is generated by the first radiation source and has a first wavelength and/or the at least one other processing beam generated by the other radiation source has a different wavelength.

4. Method according to claim 1, wherein a gas laser, in particular a carbon dioxide laser, or a fixed body laser, in particular a Nd:YAG-Laser, is used as the radiation source.

5. Method according to claim 1, wherein the other processing tool used is a material-removing means in the form of a medium, in particular a fluid or a gas, which hits the surface of the workpiece at a high relative speed thereto in order to remove material.

6. Method according to claim 1, wherein the other processing tool used is a mechanical material-removing means, for example a drill, mill, chisel or similar.

7. Method according to claim 1, wherein the other processing tool used is a material-removing means generated by a difference in electric potential, in particular an erosion spark or similar.

8. Method according to claim 1, wherein one or more of the processing tools can be switched into an inactive or passive mode and to this end are at least intermittently moved so that they do not have any processing effect on the material.

9. Method according to claim 1, wherein the processing beam constituting the processing tool is moved out of active contact with the workpiece by shutting down or throttling the output power of the at least one radiation source into the range of a zero value.

10. Method according to claim 1, wherein the active processing tool, in particular the processing beam, is placed in active contact with the workpiece by means of a feed or drive system, in particular an optical beam deflection system, for processing purposes, or is placed out of active contact with it by a shut-down or by displacing the feed or drive system.

11. Method according to claim 10, wherein the processing beam extending in the beam deflection system is placed in or out of active contact with the workpiece by controlling or regulating the disposition or position of individual deflector mirrors of the beam deflection system.

12. Method according to claim 1, wherein the co-operation of the processing tools with the workpiece is controlled or regulated by means of a control unit actively coupled with the processing tools or the feed or drive system.

13. Method according to claim 12, wherein the processing tools are activated or deactivated via at least one switch element of the control unit, in particular a respective on-off switch or a change-over switch co-operating with the processing tools in order to switch between the processing tools, or are activated or deactivated manually.

14. Method according to claim 1, wherein the processing beam are respectively directed onto the workpiece in the beam deflector system along at least one optical path extending jointly and co-linearly across a partial section.

15. Method according to claim 1, wherein the die processing beams are respectively directed onto the workpiece in the beam deflector system in optical paths extending separately or at a distance from one another depending on the radiation source generating them.

16. Method according to claim 1, wherein the contact of the one or more processing tools with the workpiece is adjusted or calibrated by means of at least one calibration tool actively coupled with the processing tools, in particular a calibration beam generated by another radiation source.

17. Method according to claim 16, wherein, by means of the calibration, a processing point on which one of the processing tools is in contact with the workpiece in active mode can be displayed by representing a focussing point on a surface of the workpiece and to this end, the other radiation source for generating the calibration beam emits coloured radiation, in particular red, green or blue light.

18. Method according to claim 16, wherein the calibration beam in the beam deflector system extends co-linearly with one or more of the optical paths of the active processing beam on the workpiece generated by one of the radiation sources.

19. Processing device for processing the material of workpieces by means of a processing tool, whereby the latter has a first radiation source, in particular a laser source, for generating a first processing tools in the form of a processing beam, wherein at least one other processing tool of a different type or different origin, in particular a different radiation source from the first processing tool is provided and the processing tools are configured for processing a workpiece alternately so that only one of the at least two processing tools is active on a workpiece to be processed at any one time.

20. Processing device according to claim 19, wherein the other processing tool is provided in the form of a processing beam generated by a radiation source that is separate from the other one, in particular a laser source.

21. Processing device according to claim 19, wherein the different radiation sources are configured to generate processing beams with different wavelengths, in particular in the form of a carbon dioxide laser and a Nd:YAG laser.

22. Processing device according to claim 19, wherein the other processing tool is provided in the form of a mechanical material-removal means, in particular a mill, drill, chisel or similar.

23. Processing device according to claim 19, wherein the other processing tool is provided in the form of a material-removal means generated by a difference in electric potential, in particular an erosion spark or similar.

24. Processing device according to claim 19, wherein the other processing tool is provided in the form of a medium which is placed or released under pressure, in particular a fluid, e.g., a water jet, or a gas.

25. Processing device according to claim 19, wherein a feed or drive system, in particular an optical beam deflection system with deflector mirrors is provided to enable one of the processing tools to make contact with or act on the workpiece.

26. Processing device according to claim 19, wherein a control unit is connected to the processing tools or the feed or drive system in order to control or regulate the co-operation of the processing tools with the workpiece.

27. Processing device according to claim 19, wherein the processing tools or the feed or drive system are actively coupled with at least one switch element, in particular an on- or off-switch or a change-over switch, of the control unit so that they can be activated or deactivated manually or on an automated basis.

28. Processing device according to claim 27, wherein the control unit is configured to set the power of the processing beam generated by the at least one radiation source between a zero level and an operating level.

29. Processing device according to claim 25, wherein the optical paths in the beam deflection system for the processing beams to be generated by the different radiation sources extend co-linearly across at least a partial section.

30. Processing device according to claim 25, wherein the optical paths in the beam deflection system for the processing beams to be generated by the different radiation sources respectively extend separately and at a distance from one another.

31. Processing device according to claim 25, wherein the optical paths of the processing beams extend across the same deflector mirrors irrespective of the radiation source generating them, or the optical paths of the processing beams for each radiation source extend at least partially across their own separately provided deflector mirrors.

32. Processing device according to claim 19, wherein a calibration tool is provided, which is designed to display a processing point on the workpiece with which one of the processing tools is in contact with the workpiece in active mode.

33. Processing device according to claim 32, wherein the calibration tool is provided in the form of a coloured calibration beam or light beam generated from a different radiation source.

34. Processing device according to claim 33, wherein the calibration beam extends in the beam deflection system co-linearly with the optical path or path of the at least one processing tool formed by the processing beam.
